(19) United States
(12) Patent Application Publication
(10) Pub. No.: US 2010/0082972 A1
(43) Pub. Date: Apr. 1, 2010

(54) Method to allow targeted advertising on mobile phones while maintaining subscriber privacy

(76) Inventors: David S. Benco, Winfield, IL (US); Mark A. Ristich, Naperville, IL (US)

Correspondence Address: Carmen Patti Law Group, LLC, One N. LaSalle Street, 44th Floor, Chicago, IL, 60602, US

(21) Appl. No.: 12/286,252

(22) Filed: Sep. 29, 2008

(51) Int. Cl. H04L 9/32

(52) U.S. Cl. 713/155

(57) ABSTRACT

An apparatus in one example has: a trusted advertising server operatively coupled to at least one terminal of a subscriber; and a trusted database having respectively at least one profile for the at least one terminal; wherein the trusted advertising server effects sending of one or more advertisements to the terminal based on the profile of the terminal without revealing an identity of the subscriber. The trusted advertising server has a trusted role and an advertising role. The trusted role is to securely maintain the at least one profile, and the advertising role is to receive target demographics for a particular advertiser or advertising broker, to match advertisements to the at least one terminal based on the respective profile in the trusted database, and to deliver the selected advertisements to the at least one terminal based on the respective profile in the trusted database.

### TECHNICAL FIELD

The invention relates generally to e-commerce, and in particular to advertising on mobile terminals, such as mobile phones.

### BACKGROUND

Advertising is a form of communication that typically attempts to persuade potential customers to purchase or to consume more of a particular brand of product or service. Many advertisements are designed to generate increased consumption of those products and services through the creation and reinforcement of “brand image” and “brand loyalty”. A few of the types of advertising are: image advertising, where the advertiser wants to convey the feel of the business—what they are about or what they believe in; institutional advertising relays the services, for example, but does not directly contain a call to action; need/benefit advertising identifies a need the consumer may have and lets the consumer know the advertiser has the answer to that need; sale advertising (or product) is a call to action based on product prices or discounts.

Today e-commerce (electronic commerce) via the Internet has become an important part of doing business. However, there are several problems. For example, Internet marketing requires customers to use newer technologies rather than traditional media. Low-speed Internet connections are another barrier. If companies and vendors build large or overly-complicated websites, individuals connected to the Internet via dial-up connections or mobile devices may experience significant delays in content delivery. However, even if a user has a high speed Internet connection, a number of problems still exist for vendors.

Traditional methods of targeted advertising are able to segment groups of consumers by cluster analysis, so it is not necessary to require the identification of any individual person. However, the placement of a targeted ad on a specific mobile handset does require knowledge of that particular individual, so a new approach is required. The technical problem at hand, therefore, is to enable targeted advertising to mobile subscribers while guaranteeing that the identity of those mobile subscribers remains private.

### SUMMARY

One embodiment according to the present method and apparatus is an apparatus that may comprise: a trusted advertising server operatively coupled to at least one terminal; and a trusted database having respectively at least one profile for the at least one terminal; wherein the trusted advertising server effects sending of one or more advertisements to the terminal based on the profile of the terminal.

Another embodiment according to the present method and apparatus is an apparatus that may comprise: a trusted advertising server operatively coupled to at least one terminal of a subscriber; and a trusted database having respectively at least one profile for the at least one terminal; wherein the trusted advertising server effects sending of one or more advertisements to the terminal based on the profile of the terminal without revealing an identity of the subscriber.

Another embodiment according to the present method and apparatus is a method that may comprise the steps of: receiving an origination or termination call, which is associated with a terminal, by one of an IMS session control, which includes the trusted application server (TAS) in applicable iFC, and a service switching function (SSF), which includes the TAS as a service control function (SCF) in applicable IN trigger subscription data; communicating the identity of the terminal to the trusted advertising server from the one of IMS session control and service switching function; checking for and extracting a profile for the terminal from a trusted database by the trusted advertising server; selecting, by the trusted advertising server, advertising based on the profile; and sending the advertising to the terminal.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 depicts an embodiment according to the present method and apparatus for an IMS subscriber.

FIG. 2 depicts an embodiment according to the present method and apparatus for a non-IMS subscriber.

FIG. 3 depicts another embodiment according to the present method and apparatus.

FIG. 4 depicts an embodiment according to the present method and apparatus for use with different communication systems.

FIG. 5 depicts a further embodiment according to the present method and apparatus for use with different communication systems.

FIG. 6 depicts a flow diagram of a method according to the present method and apparatus.

### DETAILED DESCRIPTION

The emergence of the mobile handset as a display for targeted advertising has piqued the interest of many stakeholders. For example, traditional mobile operators have been reluctant to subject their customers to generic advertisements, but are much more open to pushing targeted advertising, especially when the mobile subscriber has opted-in for such advertising. Internet-based companies such as Google have initiated the Open Handset Alliance as a means (among other things) to participate in ad placement on mobile handsets. And of course, advertisers see the mobile handset as fertile territory. However, mobile subscribers have been very protective of their privacy. For example, directories of mobile numbers do not exist, and have been met with considerable resistance by mobile customers. The personal nature of the mobile phone, coupled with the sensitivity of the general population to such things as identity theft, Internet cookies, GPS tracking services, stalking, etc. have required advertisers and their partners to tread carefully. Given the overwhelming effectiveness of targeted ads vs. banner advertising, there is clear motivation to make targeted advertising acceptable to mobile subscribers by alleviating their privacy concerns. The features of the present method and apparatus may be utilized by a variety of telecommunication systems.

In general, a telecommunication system may be a circuit switched communication system, a VoIP communication system, a video communication system, or any other type of communication system. A terminal, as used herein, may refer to a landline phone, a cellular phone, a VoIP phone, a personal data assistant, a personal computer, etc.

In telephone networks, the caller is connected to the person he wants to talk to by switches at various telephone exchanges. The switches form an electrical connection between the two users and the setting of these switches is determined electronically when the caller dials the number.

The fixed-line telephones in most residential homes are analogue. Although short-distance calls may be handled from end-to-end as analogue signals, increasingly telephone service providers are transparently converting the signals to digital for transmission before converting them back to analogue for reception. The advantage of this is that digitized voice data can travel side-by-side with data from the Internet and can be perfectly reproduced in long distance communication (as opposed to analogue signals that are inevitably impacted by noise).

Voice over Internet Protocol (VoIP) is a protocol optimized for the transmission of voice through the Internet or other packet switched networks that utilize servers. Almost the entire structure of the Internet is based upon a client-server model. A server is an application or device that performs services for connected clients as part of a client-server architecture.

VoIP systems carry telephony signals as digital audio, typically reduced in data rate using speech data compression techniques, encapsulated in a data packet stream over Internet Protocol. The Session Initiation Protocol (SIP) is a signalling protocol, widely used for setting up and tearing down multimedia communication sessions such as voice and video calls over the Internet. Other feasible application examples include video conferencing, streaming multimedia distribution, instant messaging, presence information and online games.

According to the present method and apparatus, a trusted advertising server is provided that does in fact include personal information for each opted-in mobile user. The source of information in this trusted server may be obtained via several mechanisms, such as calling patterns, network address book entries, purchases charged to IMS account, etc. The result of these data mining efforts may be a comprehensive profile of each mobile subscriber. This may be an advertiser's dream, but a consumer's nightmare. Therefore, this profile must be kept secure.

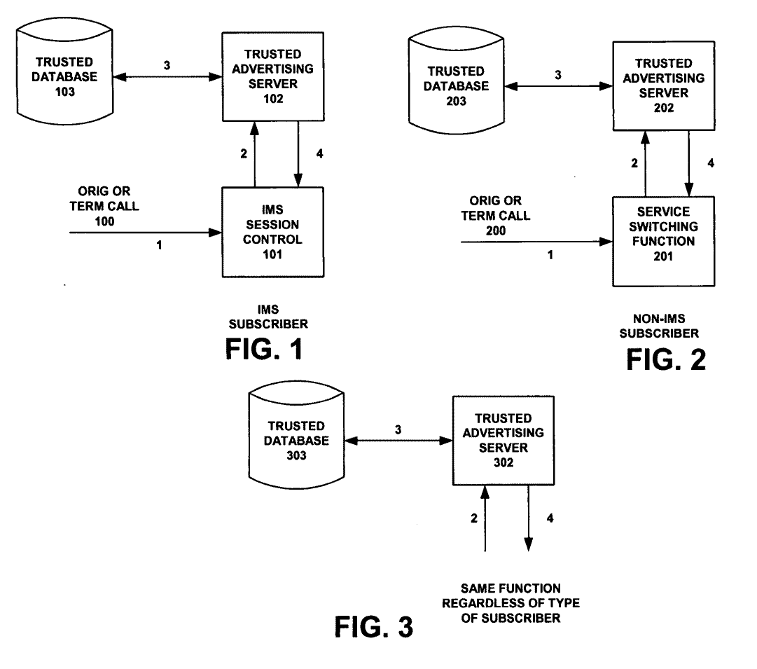

FIG. 1 depicts an embodiment according to the present method and apparatus for an IMS subscriber. In this embodiment an origination or termination call 100, which is associated with a mobile terminal, is received (path 1) by IMS session control 101, which includes the trusted application server (TAS) in applicable iFC. The IMS session control 101 communicates (path 2) with the trusted advertising server 102, which in turn checks for and extracts a profile for the mobile terminal from a trusted database 103 (path 3). The trusted advertising server 102 may then provide (path 4) one or more selected advertisements to the IMS session control 101. The IMS session control 101 may then send (path 5) the selected advertisements to the mobile terminal.

FIG. 2 depicts an embodiment according to the present method and apparatus for a non-IMS subscriber. In this embodiment an origination or termination call 200, which is associated with a mobile terminal, is received (path 1) by service switching function 201 (SSF), which includes the TAS as a service control function (SCF) in applicable IN trigger subscription data. The service switching function 201 communicates (path 2) with the trusted advertising server 202, which in turn checks for and extracts a profile for the mobile terminal from a trusted database 203 (path 3). The trusted advertising server 202 may either send an SMS with the appropriate advertisements to the user and continue the call with the SSF 201 via path 4, or may establish a temporary connection to the user to send appropriate advertisements via announcement, and then continue the call.

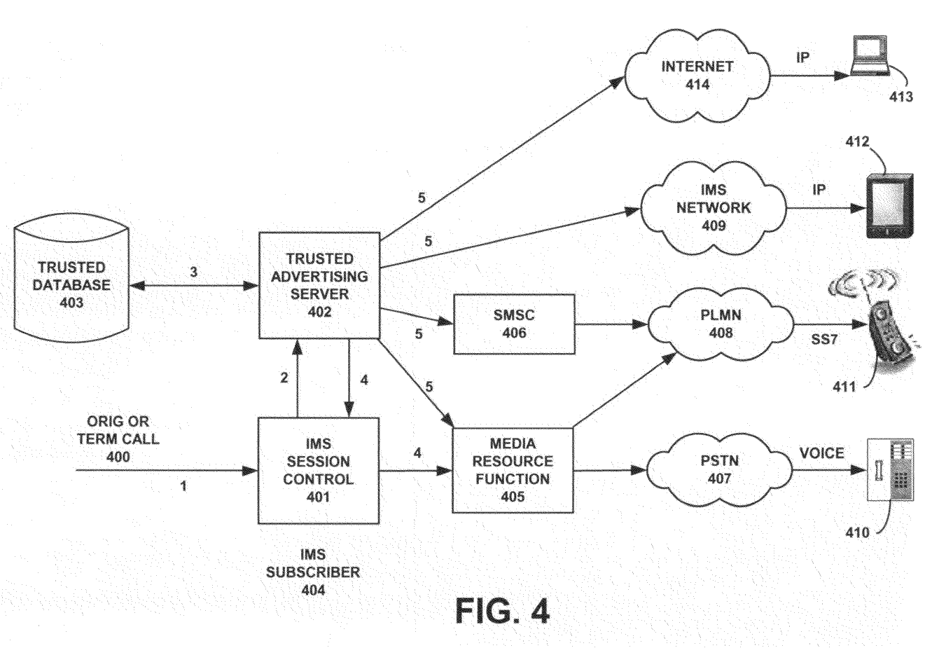

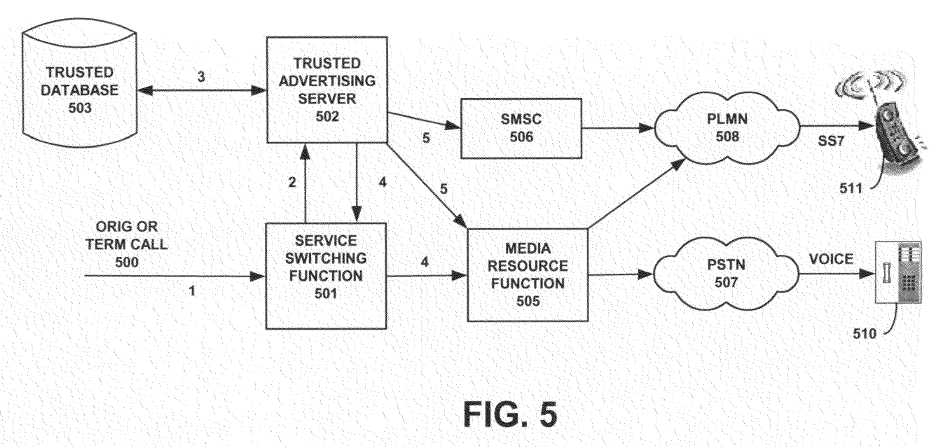

FIG. 3 depicts another embodiment according to the present method and apparatus. In this more generalized embodiment regardless of the type of subscriber the function relative to the trusted advertising server 302 is the same. From an initial communication (path 2) with the trusted advertising server 302, the trusted advertising server 302 checks for and extracts a profile for a respective mobile terminal from a trusted database 303 (path 3). The trusted advertising server 302 may then provide one or more selected advertisements to the user and then continue the call via path 4. There are a number of options for delivering the selected advertisements (see the description of FIG. 4 and FIG. 5).

Thus, prior to call setup, the trusted advertising server is invoked by the iFC (initial filter criteria) or the SSF (service switching function) and it checks the trusted database for this subscriber's advertising profile to determine the subscriber's demographic profile and any personal settings, capabilities, and restrictions. It then checks for any advertisements that meet this subscriber's particular profile and selects (based on user defined rules) the required advertisements to display and the best method to use.

The trusted role of the trusted advertising server, therefore, is to securely maintain the mobile users' profiles. The advertising role of the trusted advertising server is to receive target demographics for a particular advertiser or advertising broker, to match against appropriate mobile users in the trusted application server database, and to deliver such ads to those matched mobile users subject to those users' preferences (e.g., no more than three ads per day, etc.). Additionally, specific characteristics of the mobile subscriber's handset may be leveraged (e.g., video-capable, etc.) to display the most appropriate form of the advertisement. It is to be understood that these features are not limited to mobile users.

Embodiments of the present method and apparatus thus allow very finely targeted advertising (optimal presentation at the individual level), while the advertiser is not privy to the particular users that have received a given ad. However, the traditional cluster analysis methodologies can apply to generate metrics such as response rates from customers that have received one such ad, multiple ads, etc.

FIG. 4 depicts an embodiment according to the present method and apparatus for use with different communication systems. In this embodiment an origination or termination call 400, which is associated with a terminal of an IMS subscriber, is received (path 1) by IMS session control 401, which has an iFC. The IMS session control 401 communicates (path 2) with the trusted advertising server 402, which in turn checks for and extracts a profile for the terminal from a trusted database 403 (path 3). The trusted advertising server 402 may then provide (either the IMS session control 401 or directly via paths 5) one or more selected advertisements to the user and then continue the call via path 4.

For example, the terminal may be a landline phone 410. The IMS session control 401 may be operatively coupled to the landline phone 410 via a media resource function 405 and a PSTN 407. The terminal may also be a mobile phone 411. In this case the trusted advertising server 402 may be operatively coupled to the mobile phone 411 via a SMSC 406 and a PLMN 408. The terminal may further be a personal data assistant (PDA) 412. In this case the trusted advertising server 402 may be operatively coupled to the PDA 412 via an IMS network 409. The terminal may also be a laptop computer 413. In this case the trusted advertising server 402 may be operatively coupled to the laptop computer 413 via the Internet 414, and the selected advertisements are sent directly from the trusted advertising server 402.

FIG. 5 depicts a further embodiment according to the present method and apparatus for use with different communication systems. In this embodiment an origination or termination call 500, which is associated with a terminal of a non-IMS subscriber, is received (path 1) by a service switching function 501. The service switching function 501 communicates (path 2) with the trusted advertising server 502, which in turn checks for and extracts a profile for the terminal from a trusted database 503 (path 3). Depending on the capability of the terminal, the trusted advertising server 502 will provide one or more selected advertisements using the appropriate method. The terminal may be a landline phone 510, in which case, the service switching function 501 may be operatively coupled to the landline phone 510 via a PSTN 507. Alternatively, the terminal may also be a mobile phone 511. In this case the trusted advertising server 502 may be operatively coupled to the mobile phone 511 via a SMSC 506 and a PLMN 508. For this embodiment the selected advertisements are sent either directly from the trusted advertising server 502 using path 5 or via the SSF 501 using path 4 to establish a temporary connection so that there is a temporary voice path from an intelligent peripheral/resource function to the user (either landline or mobile).

The Internet is a worldwide network of computers and computer networks that can communicate with each other using the Internet Protocol (IP). The Internet works in part because of protocols that govern how the computers and routers communicate with each other. The nature of computer network communication lends itself to a layered approach where individual protocols in the protocol stack run more-or-less independently of other protocols. This allows lower-level protocols to be customized for the network situation while not changing the way higher-level protocols operate.

At the network layer, things become standardized with the Internet Protocol being adopted for logical addressing. For the world wide web, these “IP addresses” are derived from the human readable form using the Domain Name System.

At the transport layer, most communication adopts either the Transmission Control Protocol (TCP) or the User Datagram Protocol (UDP). TCP is used when it is essential every message sent is received by the other computer where as UDP is used when it is merely desirable. With TCP, packets are retransmitted if they are lost and placed in order before they are presented to higher layers. With UDP, packets are not ordered or retransmitted if lost.

Above the transport layer, there are certain protocols that are sometimes used and loosely fit in the session and presentation layers, most notably the Secure Sockets Layer (SSL) and Transport Layer Security (TLS) protocols. These protocols ensure that the data transferred between two parties remains completely confidential.

Embodiments according to the present method and apparatus constitute a new paradigm for supporting targeted advertising to user terminals, in particular, mobile phones, without requiring the identity of the subscriber to be revealed. Furthermore, individual subscriber preferences regarding quantity of advertising, timing of such ads, etc. can be easily accommodated as part of each mobile user's profile. Finally, ads can be optimized to the capabilities of the particular mobile handset used by a subscriber.

The profile may contain at least one of: days of the week when advertising may be received, time of day or a range of times during which advertising may be received, type or category of advertisement that may be received, and quantity of advertisement that may be received. The profile may contain other data relevant to the terminal. The trusted advertising server may have a trusted role and an advertising role. The trusted role may be to securely maintain the at least one profile for the at least one terminal. The advertising role may be to receive target demographics for a particular advertiser or advertising broker, to match advertisements to the at least one terminal based on the respective profile in the trusted database, and to deliver the selected advertisements to the at least one terminal based on the respective profile in the trusted database.

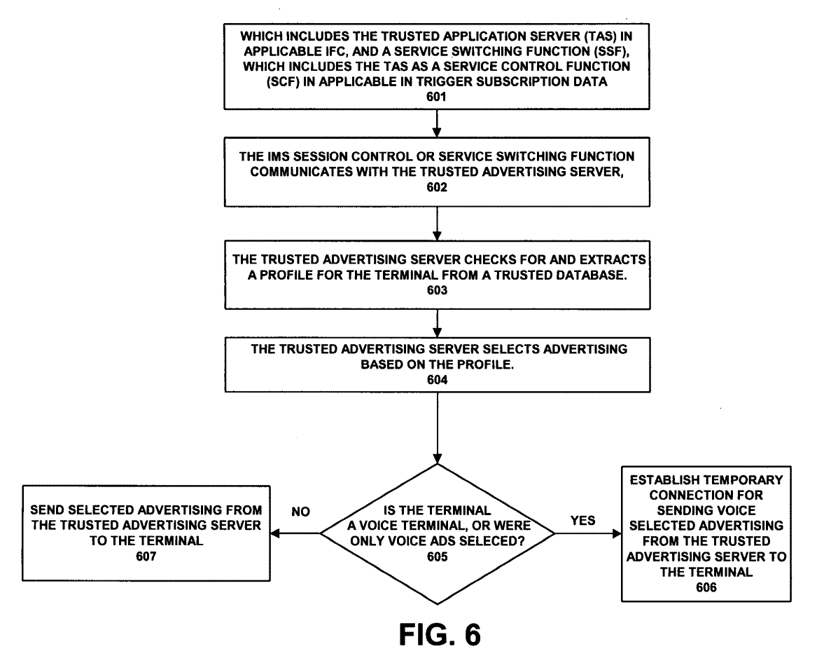

FIG. 6 depicts a flow diagram of a method according to the present method and apparatus. In this embodiment an origination or termination call, which is associated with a terminal, is received (step 601) by one of an IMS session control, which includes the trusted application server (TAS) in applicable iFC, and a service switching function (SSF), which includes the TAS as a service control function (SCF) in applicable IN trigger subscription data. The IMS session control or service switching function communicates (step 602) with the trusted advertising server, which in turn checks for and extracts (step 603) a profile for the terminal from a trusted database. The trusted advertising server may select advertising based on the profile (step 604), and may then provide (step 605) one or more selected advertisements to the user. If it is determined that the terminal is a voice terminal or if only voice ads were selected (condition is true) then a temporary connection is established for sending voice selected advertising from the trusted advertising server to the terminal (step 606). If not (condition is false), then the selected advertising is sent from the trusted advertising server to the terminal directly (either via SMS, HTTP, SIP, etc.) (step 607).

If, according to FIG. 6, the terminal is a voice only terminal, or the user selects to have only voice ads (regardless of terminal type) then the temporary connection is used (see the description above in regard to FIG. 5). Otherwise there are other choices, such as sending SMS, doing an HTTP PUT to a laptop, etc. And, of course, in the IMS cases, SIP may be used.

Embodiments according to the present method and apparatus are not limited to phone calls. The novel features of the present method and apparatus may be applied to SMSs, WAP sessions, changes in location, etc.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium for the apparatus in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following.

What is claimed is:

1. An apparatus, comprising:
a trusted advertising server operatively coupled to at least one terminal; and
a trusted database having respectively at least one profile for the at least one terminal;
wherein the trusted advertising server effects sending of at least one advertisement to the terminal based on the profile of the terminal.

2. The apparatus according to claim 1, wherein the apparatus further comprises at least one of an IMS session control, which includes the trusted application server (TAS) in applicable iFC, and a service switching function (SSF), which includes the TAS as a service control function (SCF) in applicable IN trigger subscription data, which determines, for a call associated with the terminal, if the trusted advertising server is to be sent a communication regarding the terminal for possible sending of advertisements to the terminal.

3. The apparatus according to claim 1, wherein an IMS session control is operatively coupled to the trusted advertising server, wherein the call is associated with an IMS terminal, wherein the IMS terminal is a landline phone, wherein the trusted advertising server provides at least one selected advertisement to the IMS session control, wherein the IMS session control is operatively coupled to the landline phone by a media resource function and a PSTN, and wherein the IMS session control sends the at least one selected advertisement to the landline phone.

4. The apparatus according to claim 1, wherein an IMS session control is operatively coupled to the trusted advertising server, wherein the call is associated with an IMS terminal, wherein the IMS terminal is a mobile phone, wherein the trusted advertising server provides at least one selected advertisement to the mobile phone via a SMSC service center and a PLMN.

5. The apparatus according to claim 1, wherein an IMS session control is operatively coupled to the trusted advertising server, wherein the call is associated with an IMS terminal, wherein the IMS terminal is a personal data assistant, and wherein the trusted advertising server is operatively coupled to the personal data assistant by an IMS network.

6. The apparatus according to claim 1, wherein an IMS session control is operatively coupled to the trusted advertising server, wherein the call is associated with a laptop computer, and wherein the trusted advertising server is operatively coupled to the laptop computer by the Internet.

7. The apparatus according to claim 1, wherein a service switching function is operatively coupled to the trusted advertising server, wherein the call is associated with a non-IMS terminal, wherein the trusted advertising server provides at least one selected advertisement to the service switching function, wherein the service switching function is operatively coupled to the non-IMS terminal by a PSTN, and wherein the trusted advertising server sends at least one selected advertisement to the non-IMS terminal via a voice announcement using an Intelligent Peripheral/Resource Function.

8. The apparatus according to claim 1, wherein an service switching function is operatively coupled to the trusted advertising server, wherein the call is associated with a non-IMS terminal, wherein the non-IMS terminal is a mobile phone, and wherein the trusted advertising server provides at least one selected advertisement to the mobile phone via a SMSC proxy and a PLMN.

9. An apparatus, comprising:
a trusted advertising server operatively coupled to at least one terminal of a subscriber; and
a trusted database having respectively at least one profile for the at least one terminal;
wherein the trusted advertising server effects sending of at least one advertisement to the terminal based on the profile of the terminal without revealing an identity of the subscriber.

10. The apparatus according to claim 9, wherein the terminal is one of a mobile terminal, a personal data assistant, a computer, and a landline phone.

11. The apparatus according to claim 9, wherein the profile contains at least one of: days of the week when advertising may be received, time of day or a range of times during which advertising may be received, type or category of advertisement that may be received, and quantity of advertisement that may be received.

12. The apparatus according to claim 9, wherein advertisements are optimized to capabilities of a terminal used by a subscriber.

13. The apparatus according to claim 9, wherein the apparatus further comprises at least one of an IMS session control, which includes the trusted application server (TAS) in applicable iFC, and a service switching function (SSF), which includes the TAS as a service control function (SCF) in applicable IN trigger subscription data, which determines, for a call associated with the terminal, if the trusted advertising server is to be sent a communication regarding the terminal for possible sending of advertisements to the terminal.

14. The apparatus according to claim 9, wherein the trusted advertising server has a trusted role and an advertising role, wherein the trusted role is to securely maintain the at least one profile for the at least one terminal, and wherein the advertising role is to receive target demographics for a particular advertiser or advertising broker, to match advertisements to the at least one terminal based on the respective profile in the trusted database, and to deliver the selected advertisements to the at least one terminal based on the respective profile in the trusted database.

15. A method, comprising:
receiving an origination or termination call, which is associated with a terminal, by one of an IMS session control and a service switching function;
communicating the identity of the terminal to the trusted advertising server from the one of IMS session control and service switching function;
checking for and extracting a profile for the terminal from a trusted database by the trusted advertising server;
selecting, by the trusted advertising server, advertising based on the profile; and
sending the advertising to the terminal.

16. The method according to claim 15, wherein the IMS session control includes the trusted application server (TAS) in applicable iFC, and a service switching function (SSF), which includes the TAS as a service control function (SCF) in applicable IN trigger subscription data, and wherein the method further comprises providing, by the trusted advertising server, at least one selected advertisement to the one of IMS session control and service switching function.

17. The method according to claim 16, wherein the trusted advertising server sends at least one selected advertisement to the non-IMS terminal via a voice announcement using an Intelligent Peripheral/Resource Function.

18. The method according to claim 16, wherein the IMS session control sends the at least one selected advertisement to the terminal if the terminal is a non-IMS subscriber terminal.

19. The method according to claim 16, wherein the trusted advertising server sends the at least one selected advertisement to the terminal if the terminal is an IMS subscriber terminal.

20. The apparatus according to claim 15, wherein the trusted advertising server has a trusted role and an advertising role, wherein the trusted role is to securely maintain the at least one profile for the at least one terminal, and wherein the advertising role is to receive target demographics for a particular advertiser or advertising broker, to match advertisements to the at least one terminal based on the respective profile in the trusted database, and to deliver the selected advertisements to the at least one terminal based on the respective profile in the trusted database.
